(19) United States
(12) Patent Application Publication
(10) Pub. No.: US 2022/0309848 A1
(43) Pub. Date: Sep. 29, 2022

(54) SIGNAL PROCESSING DEVICE, SIGNAL PROCESSING METHOD, PROGRAM, AND IMAGING DEVICE

(71) Applicants: SONY SEMICONDUCTOR SOLUTIONS CORPORATION, KANAGAWA (JP); SONY GROUP CORPORATION, TOKYO (JP)

(72) Inventors: KAZUHIRO HOSHINO, KANAGAWA (JP); YASUYUKI KATO, TOKYO (JP)

(21) Appl. No.: 17/611,029

(22) PCT Filed: May 15, 2020
(86) PCT No.: PCT/JP2020/019373

§ 371 Date: Nov. 12, 2021

(30) Foreign Application Priority Data
May 28, 2019 (JP) 2019-099011

(51) Int. Cl. G07C 5/08; G07C 5/00; G06V 20/58; B60R 11/04

(52) U.S. Cl. CPC G07C 5/0866; G07C 5/008; G06V 20/58; B60R 11/04

(57) ABSTRACT

The present technology relates to a signal processing device, a signal processing method, a program, and an imaging device capable of promptly making notification of abnormality such as an accident. A signal processing device includes a recognition unit that recognizes content of a captured image imaged by an imaging unit, a text information generation unit that generates text information including data representing the recognized content of the captured image in characters, and a transmission control unit that controls transmission of the text information. The present technology may be applied to, for example, a system that makes notification of abnormality of a vehicle.

### TECHNICAL FIELD

The present technology relates to a signal processing device, a signal processing method, a program, and an imaging device, and more particularly, to a signal processing device, a signal processing method, a program, and an imaging device capable of promptly making notification of abnormality.

### BACKGROUND ART

In recent years, a situation of an accident site is imaged and recorded by a drive recorder or a monitoring camera, and the recorded image is used for analysis of an accident cause and the like.

Furthermore, conventionally, it has been proposed to display a region including an object in an image with a rectangular frame, and in a case where the region is designated, extract feature point data of the object, search an information database on the basis of the feature point data, and display obtained related information of the object (e.g., see Patent Document 1).

### CITATION LIST

### Patent Document

Patent Document 1: Japanese Patent Application Laid-Open No. 2017-90220

### SUMMARY OF THE INVENTION

### Problems to be Solved by the Invention

However, while the drive recorder or the monitoring camera records an image of the accident site, it does not notify the police, a hospital, and the like of the occurrence or situation of the accident. Furthermore, for example, although it is conceivable to transmit a captured image to the police, a hospital, and the like, it is required to analyze the image, and the conveying of the occurrence or situation of the accident delays.

Meanwhile, the invention disclosed in Patent Document 1 does not consider notifying occurrence or a situation of an accident.

The present technology has been conceived in view of such a situation, and aims to promptly make notification of abnormality such as an accident.

### Solutions to Problems

A signal processing device according to one aspect of the present technology includes a recognition unit that recognizes content of a captured image imaged by an imaging unit, a text information generation unit that generates text information including data representing the recognized content of the captured image in characters, and a transmission control unit that controls transmission of the text information.

A signal processing method according to one aspect of the present technology includes recognizing content of a captured image imaged by an imaging unit, generating text information including data representing the recognized content of the captured image in characters, and controlling transmission of the text information.

A program according to one aspect of the present technology causes a computer to execute a process including recognizing content of a captured image imaged by an imaging unit, generating text information including data representing the recognized content of the captured image in characters, and controlling transmission of the text information.

According to one aspect of the present technology, content of a captured image imaged by an imaging unit is recognized, text information including data representing the recognized content of the captured image in characters is generated, and transmission of the text information is controlled.

### BRIEF DESCRIPTION OF DRAWINGS

FIG. 1 is a block diagram illustrating an exemplary configuration of a vehicle control system to which the present technology is applied.

FIG. 2 is a block diagram illustrating a first embodiment of a signal processing system.

FIG. 3 is a flowchart for explaining a first embodiment of an abnormality notification process.

FIG. 4 is a block diagram illustrating a second embodiment of the signal processing system.

FIG. 5 is a flowchart for explaining a second embodiment of the abnormality notification process.

FIG. 6 is a diagram illustrating an exemplary configuration of a computer.

### MODE FOR CARRYING OUT THE INVENTION

Hereinafter, embodiments for implementing the present technology will be described. Descriptions will be given in the following order.

1. Exemplary Configuration of Vehicle Control System

2. First Embodiment

3. Second Embodiment

4. Variations

5. Others

<<1. Exemplary Configuration of Vehicle Control System>>

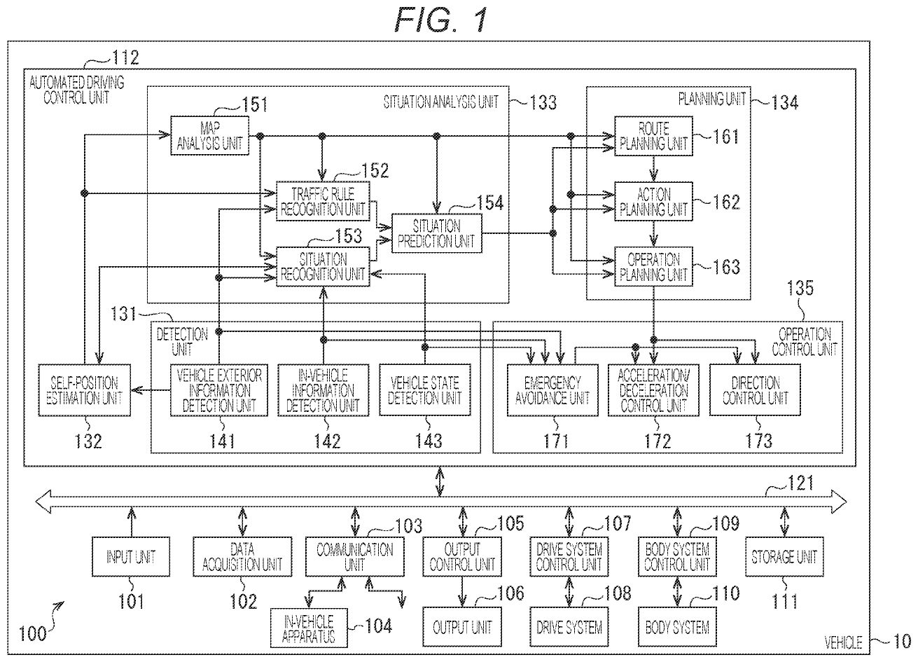

FIG. 1 is a block diagram illustrating a schematic exemplary functional configuration of a vehicle control system 100 as an example of a mobile body control system to which the present technology may be applied.

Note that, hereinafter, a vehicle 10 provided with the vehicle control system 100 will be referred to as a host vehicle in a case of being distinguished from another vehicle.

The vehicle control system 100 includes an input unit 101, a data acquisition unit 102, a communication unit 103, an in-vehicle apparatus 104, an output control unit 105, an output unit 106, a drive system control unit 107, a drive system 108, a body system control unit 109, a body system 110, a storage unit 111, and an automated driving control unit 112. The input unit 101, the data acquisition unit 102, the communication unit 103, the output control unit 105, the drive system control unit 107, the body system control unit 109, the storage unit 111, and the automated driving control unit 112 are connected to one another via a communication network 121. The communication network 121 includes, for example, a controller area network (CAN), a local interconnect network (LIN), a local area network (LAN), or an in-vehicle communication network, a bus, or the like in conformity with any standard such as FlexRay (registered trademark). Note that each unit of the vehicle control system 100 may be directly connected without the communication network 121.

Note that, hereinafter, description of the communication network 121 will be omitted in a case where each unit of the vehicle control system 100 performs communication via the communication network 121. For example, in a case where the input unit 101 and the automated driving control unit 112 communicate with each other via the communication network 121, it is simply described that the input unit 101 and the automated driving control unit 112 communicate with each other.

The input unit 101 includes a device to be used by an occupant to input various kinds of data, instructions, and the like. For example, the input unit 101 includes an operation device such as a touch panel, a button, a microphone, a switch, and a lever, an operation device that can be input by a method other than manual operation such as voice and gesture, and the like. Furthermore, for example, the input unit 101 may be a remote control device using infrared rays or other radio waves, or an external connection apparatus such as a mobile apparatus or a wearable apparatus compatible with operation of the vehicle control system 100. The input unit 101 generates input signals on the basis of data, an instruction, or the like input by the occupant, and supplies them to each unit of the vehicle control system 100.

The data acquisition unit 102 includes various sensors and the like that obtain data to be used for processing of the vehicle control system 100, and supplies the obtained data to each unit of the vehicle control system 100.

For example, the data acquisition unit 102 includes various sensors for detecting a state of a host vehicle or the like. Specifically, for example, the data acquisition unit 102 includes a gyroscope sensor, an acceleration sensor, an inertial measurement unit (IMU), a sensor for detecting, for example, an operation amount of an accelerator pedal, an operation amount of a brake pedal, a steering angle of a steering wheel, an engine speed, a motor speed, a rotation speed of a wheel, and the like.

Furthermore, for example, the data acquisition unit 102 includes various sensors for detecting information associated with the outside of the host vehicle. Specifically, for example, the data acquisition unit 102 includes an imaging device such as a Time-of-Flight (ToF) camera, a stereo camera, a monocular camera, an infrared camera, and other cameras. Furthermore, for example, the data acquisition unit 102 includes an environmental sensor for detecting weather, a meteorological phenomenon, and the like, and a surrounding information detection sensor for detecting an object around the host vehicle. The environmental sensor includes, for example, a raindrop sensor, a fog sensor, a sunshine sensor, a snow sensor, and the like. The surrounding information detection sensor includes, for example, an ultrasonic sensor, a radar, light detection and ranging/laser imaging detection and ranging (LiDAR), a sonar, and the like.

Moreover, for example, the data acquisition unit 102 includes various sensors for detecting the current position of the host vehicle. Specifically, for example, the data acquisition unit 102 includes a global navigation satellite system (GNSS) receiver or the like that receives GNSS signals from a GNSS satellite.

Furthermore, for example, the data acquisition unit 102 includes various sensors for detecting in-vehicle information. Specifically, for example, the data acquisition unit 102 includes an imaging device that images a driver, a biological sensor that detects biological information of the driver, a microphone that collects sound in the vehicle interior, and the like. The biological sensor is provided on a seat surface, a steering wheel, or the like, and detects biological information of the occupant sitting on a seat or the driver gripping the steering wheel, for example.

The communication unit 103 communicates with the in-vehicle apparatus 104 and various apparatuses, servers, base stations, and the like outside the vehicle, transmits data supplied from each unit of the vehicle control system 100, and supplies received data to each unit of the vehicle control system 100. Note that a communication protocol supported by the communication unit 103 is not particularly limited, and the communication unit 103 may support a plurality of types of communication protocols.

For example, the communication unit 103 wirelessly communicates with the in-vehicle apparatus 104 using a wireless LAN, Bluetooth (registered trademark), near field communication (NFC), a wireless universal serial bus (WUSB), or the like. Furthermore, for example, the communication unit 103 performs wired communication with the in-vehicle apparatus 104 using a universal serial bus (USB), a high-definition multimedia interface (HDMI) (registered trademark), a mobile high-definition link (MHL), or the like via a connection terminal (and a cable if necessary) (not illustrated).

Moreover, for example, the communication unit 103 communicates with an apparatus (e.g., application server or control server) that exists on an external network (e.g., the Internet, cloud network, or company-specific network) via a base station or an access point. Furthermore, for example, the communication unit 103 communicates with a terminal (e.g., terminal of a pedestrian or store, or machine type communication (MTC) terminal) that exists in the vicinity of the host vehicle using peer-to-peer (P2P) technology. Moreover, for example, the communication unit 103 performs vehicle-to-everything (V2X) communication such as vehicle-to-vehicle communication, vehicle-to-infrastructure communication, vehicle-to-home communication, and vehicle-to-pedestrian communication. Furthermore, for example, the communication unit 103 includes a beacon receiving unit, receives radio waves or electromagnetic waves transmitted from a wireless station or the like installed on a road, and obtains information such as a current position, congestion, traffic regulation, or a required time.

The in-vehicle apparatus 104 includes, for example, a mobile apparatus or wearable apparatus possessed by the occupant, an information apparatus carried in or attached to the host vehicle, a navigation device that searches for a route to any destination, and the like.

The output control unit 105 controls output of various types of information directed to the occupant of the host vehicle or to the outside of the vehicle. For example, the output control unit 105 generates output signals including at least one of visual information (e.g., image data) or auditory information (e.g., voice data), and supplies them to the output unit 106, thereby controlling output of the visual information and the auditory information from the output unit 106. Specifically, for example, the output control unit 105 synthesizes image data imaged by different imaging devices of the data acquisition unit 102 to generate an overhead image, a panoramic image, or the like, and supplies output signals including the generated image to the output unit 106. Furthermore, for example, the output control unit 105 generates voice data including a warning sound, a warning message, or the like for danger such as collision, contact, or entry into a danger zone, and supplies output signals including the generated voice data to the output unit 106.

The output unit 106 includes a device capable of outputting visual information or auditory information to the occupant of the host vehicle or to the outside of the vehicle. For example, the output unit 106 includes a display device, an instrument panel, an audio speaker, a headphone, a wearable device to be worn by the occupant, such as a glasses-type display, a projector, a lamp, and the like. The display device included in the output unit 106 may be, in addition to a device having a normal display, a device that displays visual information in the field of view of the driver, such as a head-up display, a transmissive display, or a device having an augmented reality (AR) display function, for example.

The drive system control unit 107 generates various control signals and supplies them to the drive system 108, thereby controlling the drive system 108. Furthermore, the drive system control unit 107 supplies control signals and error signals to each unit of the drive system 108 as necessary, thereby making notification of a control state and abnormality of the drive system 108 or the like.

The drive system 108 includes various devices related to the drive system of the host vehicle. For example, the drive system 108 includes a drive force generation device for generating drive force such as an internal combustion engine or a driving motor, a drive force transmission mechanism for transmitting drive force to wheels, a steering mechanism for adjusting a steering angle, a braking device for generating braking force, an antilock brake system (ABS), an electronic stability control (ESC), an electric power steering device, and the like.

The body system control unit 109 generates various control signals, and supplies them to the body system 110, thereby controlling the body system 110. Furthermore, the body system control unit 109 supplies control signals and error signals to each unit of the body system 110 as necessary, thereby making notification of a control state and abnormality of the body system 110 or the like.

The body system 110 includes various devices of the body system mounted on the vehicle body. For example, the body system 110 includes a keyless entry system, a smart key system, a power window device, a power seat, a steering wheel, an air conditioner, an airbag, a seat belt, various lamps (e.g., head lamp, back lamp, brake lamp, blinker, fog lamp, etc.), and the like.

The storage unit 111 includes, for example, a read only memory (ROM), a random access memory (RAM), a magnetic storage device such as a hard disc drive (HDD), a semiconductor storage device, an optical storage device, a magneto-optical storage device, and the like. The storage unit 111 stores various programs, data, and the like to be used by each unit of the vehicle control system 100. For example, the storage unit 111 stores map data, such as a three-dimensional high-precision map such as a dynamic map, a global map having precision less than that of the high-precision map and covering a wider area, and a local map including information around the host vehicle.

The automated driving control unit 112 performs control related to automated driving such as autonomous traveling or driving support. Specifically, for example, the automated driving control unit 112 performs cooperative control aiming at implementation of a function of the advanced driver assistance system (ADAS) including collision avoidance or impact mitigation of the host vehicle, following travel based on the distance between vehicles, vehicle speed maintenance traveling, collision warning for the host vehicle, lane departure warning for the host vehicle, or the like. Furthermore, for example, the automated driving control unit 112 performs cooperative control aiming at the automated driving or the like for autonomous traveling without depending on the operation of the driver. The automated driving control unit 112 includes a detection unit 131, a self-position estimation unit 132, a situation analysis unit 133, a planning unit 134, and an operation control unit 135.

The detection unit 131 detects various types of information required to control the automated driving. The detection unit 131 includes a vehicle exterior information detection unit 141, an in-vehicle information detection unit 142, and a vehicle state detection unit 143.

The vehicle exterior information detection unit 141 detects information outside the host vehicle on the basis of data or signals from each unit of the vehicle control system 100. For example, the vehicle exterior information detection unit 141 performs detection processing, recognition processing, and tracking processing of an object around the host vehicle, and detection processing of a distance to the object. Examples of the object to be detected include a vehicle, a person, an obstacle, a structure, a road, a traffic light, a traffic sign, and a road sign. Furthermore, for example, the vehicle exterior information detection unit 141 detects the environment around the host vehicle. Examples of the surrounding environment to be detected include weather, ambient temperature, humidity, brightness, and a state of a road surface. The vehicle exterior information detection unit 141 supplies data indicating a result of the detection processing to the self-position estimation unit 132, a map analysis unit 151, a traffic rule recognition unit 152, and a situation recognition unit 153 of the situation analysis unit 133, an emergency avoidance unit 171 of the operation control unit 135, and the like.

The in-vehicle information detection unit 142 detects in-vehicle information on the basis of data or signals from each unit of the vehicle control system 100. For example, the in-vehicle information detection unit 142 performs authentication processing and recognition processing of the driver, detection processing of a state of the driver, detection processing of the occupant, detection processing of an in-vehicle environment, and the like. Examples of the state of the driver to be detected include a physical condition, a wakefulness level, a concentration level, a fatigue level, a line-of-sight direction, and an inebriation level. Examples of the in-vehicle environment to be detected include ambient temperature, humidity, brightness, and an odor. The in-vehicle information detection unit 142 supplies data indicating a result of the detection processing to the situation recognition unit 153 of the situation analysis unit 133, the emergency avoidance unit 171 of the operation control unit 135, and the like.

The vehicle state detection unit 143 detects a state of the host vehicle on the basis of data or signals from each unit of the vehicle control system 100. Examples of the state of the host vehicle to be detected include a speed, an acceleration level, a steering angle, presence/absence and contents of abnormality, a state of driving operation, a position and inclination of a power seat, a state of door lock, a state of an airbag, a magnitude of an impact from the outside, and a state of other onboard apparatuses. The vehicle state detection unit 143 supplies data indicating a result of the detection processing to the situation recognition unit 153 of the situation analysis unit 133, the emergency avoidance unit 171 of the operation control unit 135, and the like.

The self-position estimation unit 132 estimates a position, an attitude, and the like of the host vehicle on the basis of data or signals from each unit of the vehicle control system 100 such as the vehicle exterior information detection unit 141 and the situation recognition unit 153 of the situation analysis unit 133. Furthermore, the self-position estimation unit 132 generates a local map (hereinafter referred to as self-position estimation map) to be used to estimate a self-position as necessary. The self-position estimation map is, for example, a highly accurate map using a technique such as simultaneous localization and mapping (SLAM). The self-position estimation unit 132 supplies data indicating a result of the estimation processing to the map analysis unit 151, the traffic rule recognition unit 152, and the situation recognition unit 153 of the situation analysis unit 133, and the like. Furthermore, the self-position estimation unit 132 causes the storage unit 111 to store the self-position estimation map.

The situation analysis unit 133 performs analysis processing of the host vehicle and the surrounding situation. The situation analysis unit 133 includes the map analysis unit 151, the traffic rule recognition unit 152, the situation recognition unit 153, and a situation prediction unit 154.

The map analysis unit 151 analyzes various maps stored in the storage unit 111 using data or signals from each unit of the vehicle control system 100 such as the self-position estimation unit 132 and the vehicle exterior information detection unit 141 as necessary, and builds a map including information required for the processing of the automated driving. The map analysis unit 151 supplies the built map to the traffic rule recognition unit 152, the situation recognition unit 153, the situation prediction unit 154, a route planning unit 161, action planning unit 162, and operation planning unit 163 of the planning unit 134, and the like.

The traffic rule recognition unit 152 recognizes traffic rules around the host vehicle on the basis of data or signals from each unit of the vehicle control system 100 such as the self-position estimation unit 132, the vehicle exterior information detection unit 141, and the map analysis unit 151. According to this recognition processing, for example, a position and a state of a signal around the host vehicle, contents of traffic regulations around the host vehicle, a lane on which the host vehicle can travel, and the like are recognized. The traffic rule recognition unit 152 supplies data indicating a result of the recognition processing to the situation prediction unit 154 and the like.

The situation recognition unit 153 recognizes a situation related to the host vehicle on the basis of data or signals from each unit of the vehicle control system 100 such as the self-position estimation unit 132, the vehicle exterior information detection unit 141, the in-vehicle information detection unit 142, the vehicle state detection unit 143, and the map analysis unit 151. For example, the situation recognition unit 153 recognizes a situation of the host vehicle, a situation around the host vehicle, a situation of the driver of the host vehicle, and the like. Furthermore, the situation recognition unit 153 generates a local map (hereinafter referred to as situation recognition map) to be used to recognize a situation around the host vehicle as necessary. The situation recognition map is, for example, an occupancy grid map.

Examples of the situation of the host vehicle to be recognized include a position, an attitude, and a movement (e.g., speed, acceleration level, moving direction, etc.) of the host vehicle, and presence/absence and contents of abnormality. Examples of the situation around the host vehicle to be recognized include a type and position of a surrounding stationary object, a type, position, and movement (e.g., speed, acceleration level, moving direction, etc.) of a surrounding moving object, a configuration of a surrounding road and a state of a road surface, and surrounding weather, ambient temperature, humidity, and brightness. Examples of the state of the driver to be recognized include a physical condition, a wakefulness level, a concentration level, a fatigue level, movement of a line-of-sight, and driving operation.

The situation recognition unit 153 supplies data indicating a result of the recognition processing (including the situation recognition map as necessary) to the self-position estimation unit 132, the situation prediction unit 154, and the like. Furthermore, the situation recognition unit 153 causes the storage unit 111 to store the situation recognition map.

The situation prediction unit 154 predicts a situation related to the host vehicle on the basis of data or signals from each unit of the vehicle control system 100 such as the map analysis unit 151, the traffic rule recognition unit 152, and the situation recognition unit 153. For example, the situation prediction unit 154 predicts a situation of the host vehicle, a situation around the host vehicle, a situation of the driver, and the like.

Examples of the situation of the host vehicle to be predicted include behavior of the host vehicle, occurrence of abnormality, and a travelable distance. Examples of the situation around the host vehicle to be predicted include behavior of a moving object around the host vehicle, a change in a signal state, and a change in an environment such as weather. Examples of the situation of the driver to be predicted include behavior and a physical condition of the driver.

The situation prediction unit 154 supplies, together with data from the traffic rule recognition unit 152 and the situation recognition unit 153, data indicating a result of the prediction processing to the route planning unit 161, the action planning unit 162, and the operation planning unit 163 of the planning unit 134, and the like.

The route planning unit 161 plans a route to a destination on the basis of data or signals from each unit of the vehicle control system 100 such as the map analysis unit 151 and the situation prediction unit 154. For example, the route planning unit 161 sets a route from the current position to a designated destination on the basis of the global map. Furthermore, for example, the route planning unit 161 appropriately changes the route on the basis of a situation such as congestion, an accident, traffic regulation, and construction, a physical condition of the driver, and the like. The route planning unit 161 supplies data indicating the planned route to the action planning unit 162 and the like.

The action planning unit 162 plans an action of the host vehicle for safely traveling the route planned by the route planning unit 161 within a planned time on the basis of data or signals from each unit of the vehicle control system 100 such as the map analysis unit 151 and the situation prediction unit 154. For example, the action planning unit 162 plans a start, a stop, a traveling direction (e.g., forward movement, backward movement, left turn, right turn, direction change, etc.), a traveling lane, a traveling speed, overtaking, and the like. The action planning unit 162 supplies data indicating the planned action of the host vehicle to the operation planning unit 163 and the like.

The operation planning unit 163 plans an operation of the host vehicle for implementing the action planned by the action planning unit 162 on the basis of data or signals from each unit of the vehicle control system 100 such as the map analysis unit 151 and the situation prediction unit 154. For example, the operation planning unit 163 plans acceleration, deceleration, a travel trajectory, and the like. The operation planning unit 163 supplies data indicating the planned operation of the host vehicle to an acceleration/deceleration control unit 172 and direction control unit 173 of the operation control unit 135 and the like.

The operation control unit 135 controls operation of the host vehicle. The operation control unit 135 includes the emergency avoidance unit 171, the acceleration/deceleration control unit 172, and the direction control unit 173.

The emergency avoidance unit 171 detects an emergency such as collision, contact, entry into a danger zone, abnormality of the driver, or abnormality of the vehicle on the basis of the detection results of the vehicle exterior information detection unit 141, in-vehicle information detection unit 142, and vehicle state detection unit 143. In a case where the emergency avoidance unit 171 has detected occurrence of an emergency, it plans an operation of the host vehicle for avoiding the emergency such as a sudden stop or a sudden turn. The emergency avoidance unit 171 supplies data indicating the planned operation of the host vehicle to the acceleration/deceleration control unit 172, the direction control unit 173, and the like.

The acceleration/deceleration control unit 172 performs acceleration/deceleration control for implementing the operation of the host vehicle planned by the operation planning unit 163 or the emergency avoidance unit 171. For example, the acceleration/deceleration control unit 172 calculates a control target value of the drive force generation device or the braking device for implementing the planned acceleration, deceleration, or sudden stop, and supplies a control command indicating the calculated control target value to the drive system control unit 107.

The direction control unit 173 performs direction control for implementing the operation of the host vehicle planned by the operation planning unit 163 or the emergency avoidance unit 171. For example, the direction control unit 173 calculates a control target value of the steering mechanism for implementing the travel trajectory or sudden turn planned by the operation planning unit 163 or the emergency avoidance unit 171, and supplies a control command indicating the calculated control target value to the drive system control unit 107.

### 2. First Embodiment

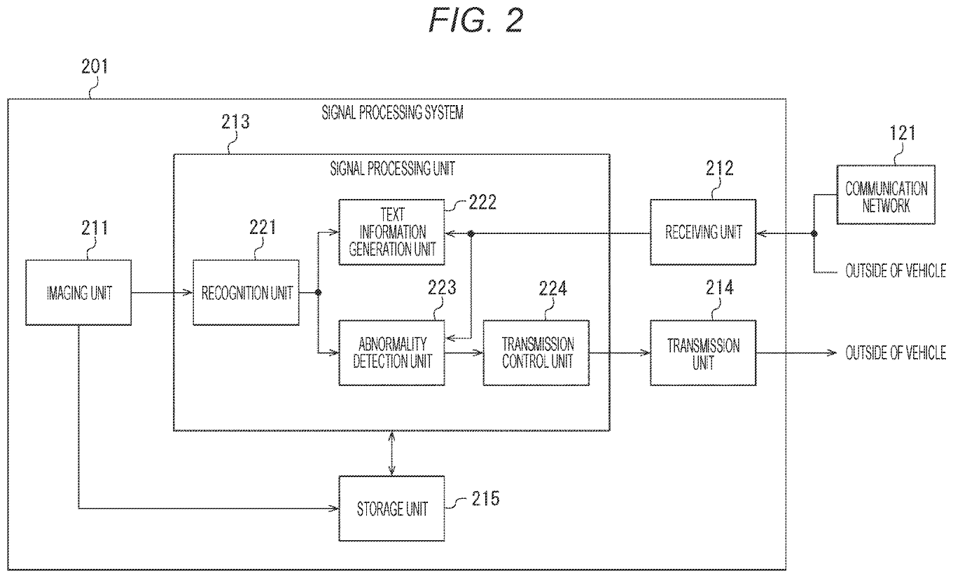

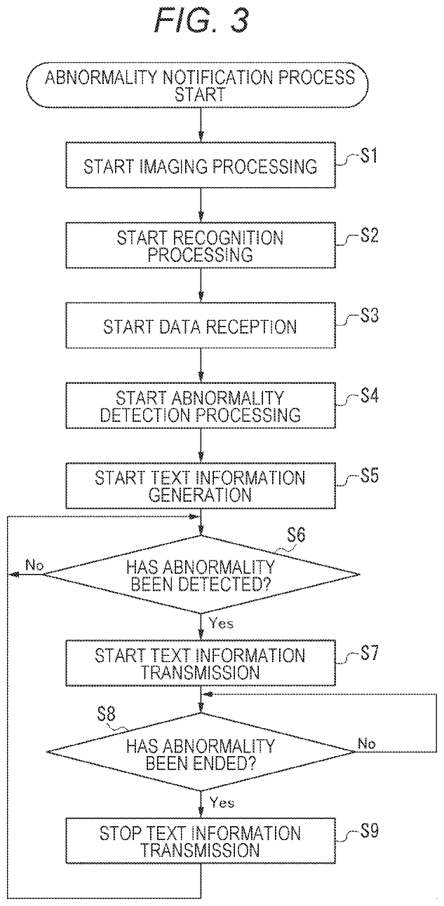

Next, a first embodiment of the present technology will be described with reference to FIGS. 2 and 3.

<Exemplary Configuration of Signal Processing System 201>

FIG. 2 illustrates an exemplary configuration of a signal processing system 201 to which the present technology is applied.

The signal processing system 201 is a system that recognizes content of a captured image, detects abnormality on the basis of a recognition result and the like, and transmits, to a predetermined notification destination, text information including data (hereinafter referred to as character data) representing the recognition result and the like in characters in a case where abnormality has been detected.

Note that the character data includes, in addition to what is called text data, data obtained by imaging data represented by characters and the like, for example.

Furthermore, FIG. 2 illustrates an exemplary case where the signal processing system 201 is provided in a vehicle 10 and detects abnormality (e.g., accident, abnormality of a driver, etc.) of at least one of the vehicle 10 or the surroundings of the vehicle 10.

The signal processing system 201 includes an imaging unit 211, a receiving unit 212, a signal processing unit 213, a transmission unit 214, and a storage unit 215.

The imaging unit 211 images at least one of the surroundings or the inside of the vehicle 10, for example. The imaging unit 211 supplies image data including an image having been captured (hereinafter referred to as captured image) to the signal processing unit 213, and causes the storage unit 215 to store the image data. The imaging unit 211 constitutes a part of a data acquisition unit 102 of a vehicle control system 100, for example.

The receiving unit 212 receives data to be used for abnormality detection and text information generation from the outside of the vehicle and the inside of the vehicle via a communication network 121, and supplies the received data to the signal processing unit 213. The receiving unit 212 constitutes a part of a communication unit 103 of the vehicle control system 100 and a part of a communication unit (not illustrated) of an automated driving control unit 112, for example.

The signal processing unit 213 detects abnormality on the basis of image data and received data, and in a case where abnormality has been detected, generates text information to supplies it to the transmission unit 214. The signal processing unit 213 constitutes a part of a detection unit 131 and a situation recognition unit 153 of the automated driving control unit 112 of the vehicle control system 100, for example, and includes a recognition unit 221, a text information generation unit 222, an abnormality detection unit 223, and a transmission control unit 224.

The recognition unit 221 recognizes the content of the captured image, and supplies recognition data indicating a recognition result to the text information generation unit 222 and to the abnormality detection unit 223. A recognition model constructed by machine learning, such as deep learning, is used for the recognition unit 221, for example.

The text information generation unit 222 generates text information including character data representing the content of the captured image (recognition data) and the content of the received data, and causes the storage unit 215 to store it.

The abnormality detection unit 223 detects abnormality on the basis of the recognition data and the received data, and supplies data indicating a detection result to the transmission control unit 224.

The transmission control unit 224 controls transmission of the text information by the transmission unit 214 on the basis of the abnormality detection result.

The transmission unit 214 transmits the text information to a predetermined notification destination outside the vehicle under the control of the transmission control unit 224. Note that a communication method of the transmission unit 214 is not particularly limited. The transmission unit 214 constitutes a part of the communication unit 103 of the vehicle control system 100, for example.

The storage unit 215 constitutes a part of a storage unit 111 of the vehicle control system 100.

<Abnormality Notification Process>

Next, an abnormality notification process to be executed by the signal processing system 201 will be described with reference to the flowchart of FIG. 3.

This process starts when the power of the signal processing system 201 is turned on, for example, and ends when it is turned off.

In step S1, the imaging unit 211 starts imaging processing. Specifically, the imaging unit 211 starts imaging to supply image data including the obtained captured image to the recognition unit 221, and also starts processing of causing the storage unit 215 to store the image data. Note that the image data stored in the storage unit 215 is erased after a predetermined time (e.g., in an hour), for example.

In step S2, the recognition unit 221 starts recognition processing. Specifically, the recognition unit 221 recognizes the content of the captured image, and starts processing of supplying recognition data indicating a recognition result to the text information generation unit 222 and to the abnormality detection unit 223.

Examples of the content of the captured image to be recognized include information associated with abnormality to be detected by the abnormality detection unit 223 (e.g., information to be used for detection and analysis of abnormality).

For example, in a case where the captured image is an image obtained by imaging the surroundings of the vehicle 10, characteristics and a state of the surrounding vehicle, characteristics of a driver of the surrounding vehicle, characteristics and a position of a surrounding pedestrian (including a two-wheel vehicle), a surrounding situation, and the like are to be recognized.

Examples of the characteristics of the surrounding vehicle include a vehicle type, a color, and contents of a license plate.

Examples of the state of the surrounding vehicle include a speed and a traveling direction.

Examples of the characteristics of the driver of the surrounding vehicle and the pedestrian include a gender, an age, a physical size, a hairstyle, a skin color, clothes, and an accessory (e.g., hat, glasses, etc.). Note that personal information obtained by facial recognition or the like based on the captured image may be included, for example.

Examples of the surrounding situation include weather, a state of a road surface, presence/absence of an obstacle, presence/absence of accident occurrence, and a situation of the accident. Examples of the accident situation include a type of the accident (e.g., single accident, property damage accident, bodily injury accident, etc.), presence/absence of an injured person, a vehicle damage situation, and presence/absence of fire occurrence.

Furthermore, for example, in a case where the captured image is an image obtained by imaging the inside of the vehicle 10, the characteristics, state, and the like of the driver of the vehicle 10 are to be recognized.

The characteristics of the driver of the vehicle 10 are similar to the characteristics of the driver of the surrounding vehicle of the vehicle 10 described above, for example.

Examples of the state of the driver of the vehicle 10 include a physical condition, a wakefulness level (e.g., presence/absence of dozing), a concentration level, a fatigue level, a line-of-sight direction, an inebriation level (e.g., possibility of drinking), and whether or not a seat belt is worn. Note that the state of the driver is recognized by a driver monitoring system (DMS) or the like, for example. The possibility of drinking is recognized by a pupil saccade or the like, for example.

In step S3, the receiving unit 212 starts data reception. Specifically, the receiving unit 212 starts processing of receiving data from the outside of the vehicle and the inside of the vehicle via the communication network 121, and supplying it to the text information generation unit 222 and to the abnormality detection unit 223.

Examples of the received data include information associated with abnormality to be detected by the abnormality detection unit 223 (e.g., information to be used for detection and analysis of abnormality). For example, the received data from the outside of the vehicle includes data received by the communication unit 103 from an in-vehicle apparatus 104, an apparatus existing on an external network, a terminal and base station existing in the vicinity of the vehicle 10, another vehicle, a pedestrian, incidental equipment of a road, home, and the like. Examples of the data received from the inside of the vehicle include data indicating results of the detection processing by the vehicle exterior information detection unit 141, the in-vehicle information detection unit 142, and the vehicle state detection unit 143 described above, and voice data of the inside of the vehicle 10 obtained by a microphone included in the input unit 101.

In step S4, the abnormality detection unit 223 starts to detect abnormality on the basis of the recognition data and the received data.

For example, the abnormality detection unit 223 detects an accident involving the vehicle 10 on the basis of a state of the airbag of the vehicle 10, a magnitude of an impact on the vehicle 10 from the outside, and the like. Furthermore, for example, the abnormality detection unit 223 detects an accident around the vehicle 10 on the basis of information associated with the surrounding situation of the vehicle 10. Note that the accident around the vehicle 10 does not necessarily involve the vehicle 10, and may include an accident between other vehicles. Moreover, for example, the abnormality detection unit 223 starts to detect abnormality of the driver on the basis of information associated with the state of the driver. Examples of the abnormality of the driver to be detected include dozing, a state of inebriation, syncope, a cramp, and bleeding.

In step S5, the text information generation unit 222 starts to generate text information. Specifically, the text information generation unit 222 starts processing of generating text information including character data representing at least one of the content of the captured image (recognition data), the content of the data received from the outside of the vehicle, or the content of the data received from the inside of the vehicle and causing the storage unit 215 to store the text information. With this arrangement, the text information is continuously generated without being changed by the abnormality detection result. Note that the text information stored in the storage unit 215 is erased after a predetermined time (e.g., in a minute), for example.

Examples of the text information include information associated with abnormality to be detected by the abnormality detection unit 223.

Examples of the information associated with abnormality include information indicating contents of the abnormality, information indicating a risk of the abnormality, and information to be used to analyze the abnormality.

Specifically, for example, the text information includes character data representing the characteristics and the state of the surrounding vehicle of the vehicle 10, the characteristics of the driver of the surrounding vehicle, the characteristics and the position of the surrounding pedestrian, the surrounding situation, and the characteristics and the state of the driver of the vehicle 10 described above.

Note that, for example, in a case where an accident occurs, the text information may also include character data representing information associated with, in addition to the vehicle that has caused the accident, surrounding vehicles other than the vehicle (e.g., contents of a license plate). With this arrangement, for example, it becomes possible to collect witness information of an accident from drivers or the like of surrounding vehicles at a later time.

For example, the text information includes information associated with the vehicle 10, which is, for example, character data representing characteristics and a state of the vehicle 10. The characteristics and the state of the vehicle 10 are similar to the characteristics and the state of the surrounding vehicle of the vehicle 10 described above, for example.

For example, in a case where an accident has occurred, the text information includes character data representing information associated with a situation of the accident. Examples of the situation of the accident include time of occurrence, a site of occurrence, an accident type, presence/absence of an injured person, a vehicle damage situation, and presence/absence of fire occurrence.

For example, the text information includes character data of contents (i.e., content of the voice) obtained by performing voice recognition on the voice data of the inside of the vehicle 10.

In step S6, the abnormality detection unit 223 determines whether or not abnormality has been detected on the basis of the result of the abnormality detection processing. The determination processing of step S6 is repeatedly executed until it is determined that abnormality has been detected. Then, in a case where it is determined that abnormality has been detected, the process proceeds to step S7.

In step S7, the signal processing system 201 starts transmission of the text information. Specifically, the abnormality detection unit 223 notifies the transmission control unit 224 of the occurrence of abnormality.

The transmission control unit 224 reads, from the storage unit 215, the text information generated during the period of time from the time a predetermined time before the abnormality is detected (e.g., 10 seconds before) to the time at which the abnormality is detected, and transmits it to a predetermined notification destination via the transmission unit 214. Furthermore, the transmission control unit 224 starts processing of reading the latest text information generated by the text information generation unit 222 from the storage unit 215 and transmitting it to a predetermined notification destination.

The notification destination is set to a predetermined center, for example. Then, for example, text information is transferred from the center to various related places such as the police, a hospital, an insurance company, and a security company, or notification based on the text information is made as necessary. Note that the notification destination may be directly set to each related place, for example.

In step S8, the abnormality detection unit 223 determines whether or not the abnormality has ended on the basis of the result of the abnormality detection processing. The determination processing of step S8 is repeatedly executed until it is determined that the abnormality has ended, and in a case where it is determined that the abnormality has ended, the process proceeds to step S9.

In step S9, the signal processing system 201 stops the transmission of the text information. Specifically, the abnormality detection unit 223 notifies the transmission control unit 224 of the end of the abnormality.

The transmission control unit 224 stops the transmission of the text information.

Note that, for example, the transmission control unit 224 may continue the transmission of the text information for a predetermined time after it is determined that the abnormality has ended.

Thereafter, the process returns to step S6, and the processing of step S6 and subsequent processing are executed.

As described above, in a case where an accident, abnormality of the driver, or the like has occurred, text information including character data representing information associated with the occurred abnormality is transmitted to a predetermined notification destination.

With this arrangement, it becomes possible to use the text information without the image being analyzed or the like at the notification destination and the transfer destination. As a result, the occurrence and situation of the abnormality are promptly grasped to execute the action for the abnormality. For example, in a case where there is an injured person, an ambulance can immediately head to the accident site. For example, in a case where a fire has occurred, a fire engine can immediately head to the accident site. For example, in a case where an accident vehicle has escaped, the police can immediately perform tracking or a crackdown.

### 3. Second Embodiment

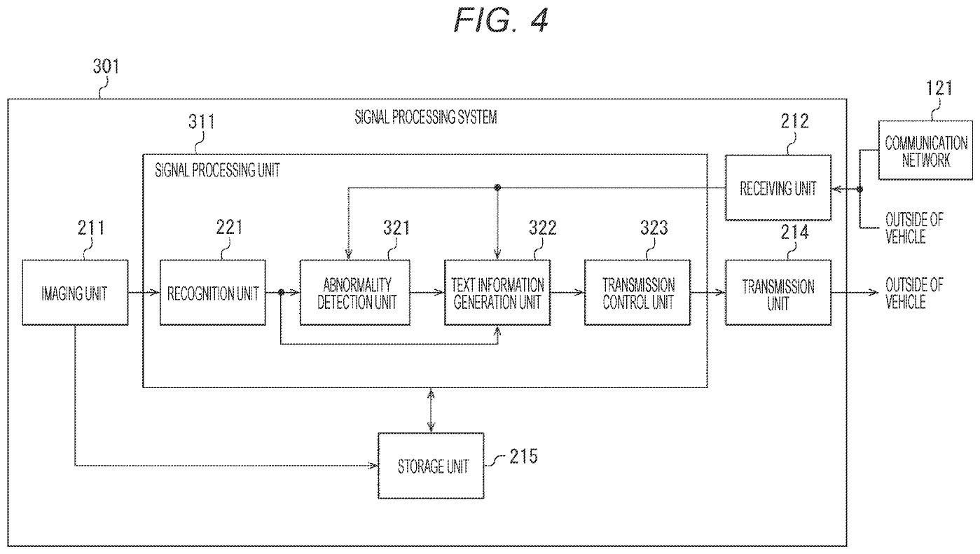

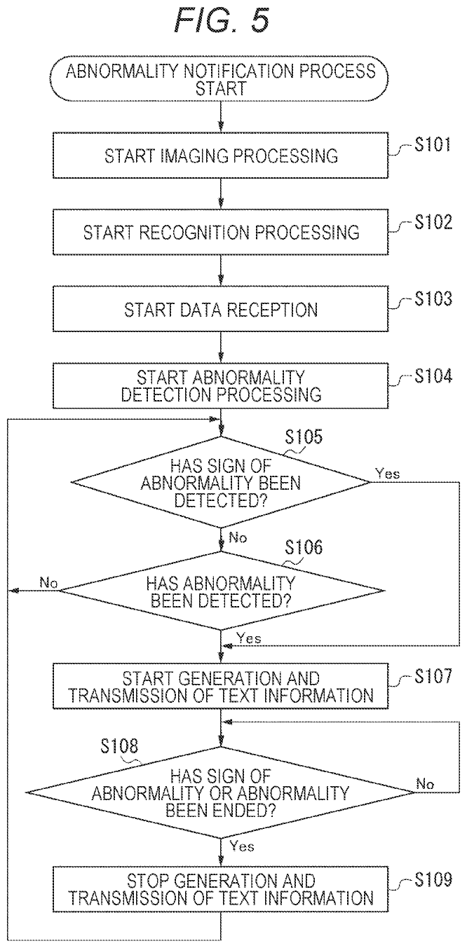

Next, a second embodiment of the present technology will be described with reference to FIGS. 4 and 5.

In the second embodiment, generation of text information is started or stopped as necessary.

<Exemplary Configuration of Signal Processing System 301>

FIG. 4 illustrates an exemplary configuration of a signal processing system 301 to which the present technology is applied. Note that, in a similar manner to FIG. 2, FIG. 4 illustrates an exemplary case where the signal processing system 301 is provided in a vehicle 10 and detects abnormality (e.g., accident, abnormality of a driver, etc.) of at least one of the vehicle 10 or the surroundings of the vehicle 10. Furthermore, in the drawing, a part corresponding to that of the signal processing system 201 of FIG. 2 is denoted by the same reference sign, and descriptions thereof will be omitted as appropriate.

As compared with the signal processing system 201, the signal processing system 301 is identical in that an imaging unit 211, a receiving unit 212, a transmission unit 214, and a storage unit 215 are included, and is different in that a signal processing unit 311 is included instead of a signal processing unit 213. As compared with the signal processing unit 213, the signal processing unit 311 is identical in that a recognition unit 221 is included, and is different in that an abnormality detection unit 321, a text information generation unit 322, and a transmission control unit 323 are included instead of an abnormality detection unit 223, a text information generation unit 222, and a transmission control unit 224.

As compared with the abnormality detection unit 321 of the signal processing system 201, the abnormality detection unit 321 is identical in that abnormality is detected on the basis of recognition data and received data, and is different in that a sign of abnormality is further detected. The abnormality detection unit 321 supplies data indicating a detection result to the text information generation unit 322.

In a similar manner to the text information generation unit 222, the text information generation unit 322 generates text information on the basis of recognition data and received data. However, unlike the text information generation unit 222, the text information generation unit 322 starts or stops the generation of the text information on the basis of a sign of the abnormality and a detection result of the abnormality. The text information generation unit 322 supplies the generated text information to the transmission control unit 323, and causes the storage unit 215 to store the text information.

In a case where the transmission control unit 323 obtains the text information from the text information generation unit 322, it transmits the obtained text information to a predetermined notification destination via the transmission unit 214.

<Abnormality Notification Process>

Next, an abnormality notification process to be executed by the signal processing system 301 will be described with reference to the flowchart of FIG. 5.

This process starts when the power of the signal processing system 301 is turned on, for example, and ends when it is turned off.

In steps S101 to S103, a process similar to that in steps S1 to S3 of FIG. 3 is executed.

In step S104, the abnormality detection unit 321 starts to detect abnormality. Specifically, in a similar manner to the processing of the abnormality detection unit 223 of step S7 in FIG. 3, the abnormality detection unit 321 starts to detect abnormality, and also starts to detect a sign of abnormality.

Examples of the sign of abnormality to be detected include a risk factor leading to an accident and an operation for avoiding the accident. Examples of the risk factor leading to an accident include unsafe driving of the vehicle 10 and a surrounding vehicle, a dangerous pedestrian (including a two-wheel vehicle), abnormality of a driver, and a surrounding unsafe situation.

Examples of the unsafe driving of the vehicle 10 and the surrounding vehicle include drowsy driving, drunk-driving, non-lighting driving, inattentive driving, meandering driving, wrong-way driving, signal ignoring, tailgating, overspeed, slip, sudden start, sudden acceleration, sudden braking, and abrupt steering.

Examples of the dangerous pedestrian include a pedestrian who is running out (who may run out), a pedestrian in a blind spot of the driver of the vehicle 10, a pedestrian ignoring a traffic light, a pedestrian on a vehicular road, and a meandering pedestrian.

Examples of the surrounding unsafe situation include an earthquake, a dense fog, a flood, a storm, a snowstorm, a fire, a rock fall, an obstacle, road caving, and road freezing.

Examples of the operation for avoiding the accident include sudden braking and abrupt steering.

In step S105, the abnormality detection unit 321 determines whether or not a sign of abnormality has been detected. In a case where it is determined that no sign of abnormality has been detected, the process proceeds to step S106.

In step S106, in a similar manner to the processing of step S6 in FIG. 3, it is determined whether or not abnormality has been detected. In a case where it is determined that no abnormality has been detected, the process returns to step S105.

Thereafter, the processing of steps S105 and S106 is repeatedly executed until it is determined in step S105 that a sign of abnormality has been detected or it is determined in step S106 that abnormality has been detected.

On the other hand, in a case where it is determined in step S105 that a sign of abnormality has been detected, that is, in a case where the risk of occurrence of abnormality increases, the processing of step S106 is skipped, and the process proceeds to step S107.

Furthermore, in a case where it is determined in step S106 that abnormality has been detected, the process proceeds to step S107. This is a case where abnormality has been suddenly detected without a sign of the abnormality being detected.

In step S107, the signal processing system 301 starts generation and transmission of text information. Specifically, the abnormality detection unit 321 notifies the text information generation unit 322 of the fact that a sign of abnormality or abnormality has been detected.

In a similar manner to the processing of the text information generation unit 222 of step S5 in FIG. 3, the text information generation unit 322 starts to generate text information. Furthermore, the text information generation unit 322 starts processing of supplying the generated text information to the transmission control unit 323 and causing the storage unit 215 to store the text information. Note that the text information stored in the storage unit 215 is erased after a predetermined time (e.g., in a minute), for example.

Note that, in a case where a sign of abnormality has been detected, the text information includes character data representing information associated with the sign of abnormality, for example. Examples of the information associated with the sign of abnormality include the contents of the sign of abnormality and the occurrence time and occurrence place of the sign of abnormality.

For example, with the information associated with unsafe driving, which is one of the signs of abnormality, included in the text information, analysis accuracy of an accident is improved in a case where an accident has occurred, whereby it becomes possible to accurately identify a cause of the accident and the like.

The transmission control unit 323 starts processing of transmitting the text information obtained from the text information generation unit 322 to a predetermined notification destination via the transmission unit 214.

In step S108, the abnormality detection unit 321 determines whether or not the sign of abnormality or the abnormality has ended. This determination processing is repeatedly executed until it is determined that the sign of abnormality or the abnormality has ended. Then, in a case where it is determined that the sign of abnormality or the abnormality has ended, the process proceeds to step S109. This includes a case where abnormality is detected after a sign of abnormality is detected and then no abnormality is detected thereafter, a case where, after a sign of abnormality is detected, no sign of abnormality is detected without abnormality being detected, and a case where abnormality is detected without a sign of the abnormality being detected and then no abnormality is detected thereafter.

In step S109, the signal processing system 301 stops the generation and transmission of the text information. Specifically, the abnormality detection unit 321 notifies the text information generation unit 322 of the fact that the sign of abnormality or the abnormality has ended.

The text information generation unit 322 stops the generation of the text information. The transmission control unit 323 stops the processing of transmitting the text information.

Note that, for example, the text information generation unit 322 and the transmission control unit 323 may continue the generation and transmission of the text information for a predetermined time after it is determined that the sign of abnormality or the abnormality has ended.

Thereafter, the process returns to step S105, and the processing of step S105 and subsequent processing are executed.

As described above, a sign of abnormality is detected, and text information is generated after the risk of occurrence of abnormality increases, whereby the processing of the signal processing system 301 can be reduced.

Furthermore, in addition to a case where abnormality is detected, also in a case where a sign of abnormality is detected, text information is generated and transmitted. With this arrangement, it becomes possible to prepare for the occurrence of abnormality in advance in the notification destination of the text information, whereby it becomes possible to promptly respond to the occurrence of abnormality. Furthermore, it becomes possible to analyze the abnormality more accurately an in detail.

<<4. Variations>>

Hereinafter, variations of the embodiments according to the present technology described above will be described.

The signal processing system 201 and the signal processing system 301 may include, for example, one semiconductor chip or a plurality of semiconductor chips.

For example, the imaging unit 211 of the signal processing system 201 may be provided in an image sensor, and other units may be provided in another semiconductor chip (e.g., semiconductor chip for the ADAS). For example, a part (e.g., recognition unit 221) or all of the imaging unit 211 and the signal processing unit 213 may be provided in an image sensor, and other units may be provided in another semiconductor chip (e.g., semiconductor chip for the ADAS). For example, the signal processing system 201 may include one image sensor.

Similarly, for example, the imaging unit 211 of the signal processing system 301 may be provided in an image sensor, and other units may be provided in another semiconductor chip (e.g., semiconductor chip for the ADAS). For example, a part (e.g., recognition unit 221) or all of the imaging unit 211 and the signal processing unit 311 may be provided in the image sensor, and other units may be provided in another semiconductor chip (e.g., semiconductor chip for the ADAS). For example, the signal processing system 301 may include one image sensor.

Furthermore, for example, the signal processing system 201 and the signal processing system 301 may include one device, or may include a plurality of devices having different casings.

For example, the signal processing system 201 may include one imaging device. For example, the imaging unit 211 of the signal processing system 201 may be provided in an imaging device, and other units may be provided in an electronic control unit (ECU) for the ADAS of a vehicle.

Similarly, for example, the signal processing system 301 may include one imaging device. For example, the imaging unit 211 of the signal processing system 301 may be provided in an imaging device, and other units may be provided in the ECU for the ADAS of the vehicle.

Moreover, for example, in the first embodiment, generation of text information starts in a case where a sign of abnormality has detected, and the generation of text information stops in a case where the sign of abnormality or the abnormality has ended in a similar manner to the second embodiment.

Furthermore, for example, in the second embodiment, transmission of text information starts in a case where abnormality has detected in a similar manner to the first embodiment. Moreover, for example, text information generated during the period of time from the time a predetermined time before the abnormality is detected to the time at which the abnormality is detected may be transmitted in a similar manner to the first embodiment.

Furthermore, for example, after the text information is transmitted for a predetermined time after abnormality is detected, the transmission of the text information may be stopped regardless of whether or not the abnormality has ended.

Moreover, for example, in a case where the vehicle 10 cannot transmit the text information to the notification destination due to a failure or the like, the text information may be transmitted to a surrounding vehicle and the surrounding vehicle may transmit the text information to the notification destination on behalf of the vehicle 10 if communication with the surrounding vehicle is possible by short-range communication.

Furthermore, for example, the signal processing system 201 and the signal processing system 301 may be installed at a fixed place, and may be used for monitoring abnormality in a predetermined monitoring area, such as a traffic accident. Assumed examples of the target monitoring area include an intersection, a highway, and a railroad crossing.

In this case, the text information includes character data representing information associated with a situation of the monitoring area, for example. Examples of the information associated with a situation of the monitoring area include a vehicle, a driver, a pedestrian, weather, a state of a road surface, presence/absence of an obstacle, presence/absence of accident occurrence, and a situation of the accident in the monitoring area, and contents of voice recognition of voice data in the monitoring area.

Moreover, the signal processing system 201 and the signal processing system 301 may be provided in a mobile body other than the vehicle, and may be used for notification of various types of abnormality of the mobile body. Assumed examples of the target mobile body include a motorcycle, a bicycle, a personal mobility, an airplane, a ship, a construction machine, and an agricultural machine (farm tractor). Furthermore, for example, a mobile body to be remotely driven (operated) without being boarded by a user, such as a drone or a robot, is also included. Assumed examples of the abnormality to be notified include an accident, falling, destruction, and failure.

In this case, for example, the text information includes character data representing information associated with a mobile body, a driver (in a case where a driver exists) of the mobile body, and a situation of abnormality (e.g., accident, etc.), and character data representing contents of voice recognition of voice data in the mobile body. Furthermore, in a case where an accident involving a mobile body has occurred and there is an opposite party of the accident, the text information includes character data representing information associated with the opposite party of the accident, for example.

Moreover, the signal processing system 201 and the signal processing system 301 may be provided in a predetermined monitoring area, and may be used for crime prevention, disaster prevention, and the like. Assumed examples of the target monitoring area include various facilities (e.g., store, company, school, factory, station, airport, warehouse, etc.), premises, streets, parking lots, residences, and places where natural disasters are assumed to occur. Assumed examples of the abnormality to be notified include entry of a suspicious person, theft, destruction, suspicious behavior, a fire, and natural disasters (e.g., flood, tsunami, eruption, etc.).

In this case, the text information includes character data representing information associated with a situation of the monitoring area, for example. Examples of the information associated with the situation of the monitoring area include a person, an object, weather, presence/absence of abnormality occurrence, and a situation of the abnormality in the monitoring area, and contents of voice recognition of voice data in the monitoring area.

Furthermore, for example, the content of the text information may be changed according to the situation. Furthermore, for example, the text information may be transmitted a plurality of times.

Furthermore, for example, the processing described above may be carried out using only the image data without using the received data.

Moreover, the text information may be used for a dynamic map to be used for automated driving, for example. The dynamic map includes, for example, static information with little temporal change such as a road surface, a lane, and a structure, quasi-static information such as a management traffic regulation schedule and a road construction schedule, quasi-dynamic information such as an accident and congestion, and dynamic information such as surrounding vehicles and signal information. Then, for example, the text information is used to update the quasi-dynamic information in a center of a notification destination or the like.

<<5. Others>>

<Exemplary Computer Configuration>

The series of processing described above may be executed by hardware or by software. In a case where the series of processing is executed by software, a program included in the software is installed in a computer. Here, examples of the computer include a computer incorporated in dedicated hardware, a general-purpose personal computer capable of executing various functions by installing various programs, and the like.

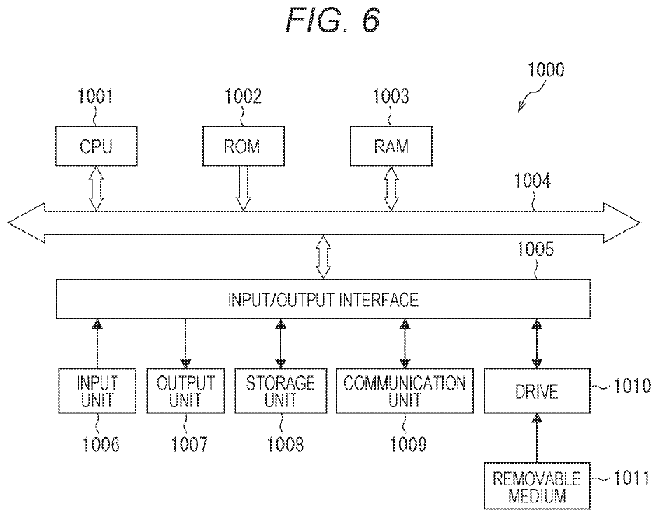

FIG. 6 is a block diagram illustrating an exemplary hardware configuration of a computer that executes, using a program, the series of processing described above.

In a computer 1000, a central processing unit (CPU) 1001, a read only memory (ROM) 1002, and a random access memory (RAM) 1003 are coupled to one another via a bus 1004.

An input/output interface 1005 is further connected to the bus 1004. An input unit 1006, an output unit 1007, a recording unit 1008, a communication unit 1009, and a drive 1010 are connected to the input/output interface 1005.

The input unit 1006 includes an input switch, a button, a microphone, an image pickup device, and the like. The output unit 1007 includes a display, a speaker, and the like. The recording unit 1008 includes a hard disk, a non-volatile memory, and the like. The communication unit 1009 includes a network interface, and the like. The drive 1010 drives a removable medium 1011 such as a magnetic disk, an optical disk, a magneto-optical disk, or a semiconductor memory.

In the computer 1000 configured as described above, for example, the CPU 1001 loads the program stored in the recording unit 1008 into the RAM 1003 via the input/output interface 1005 and the bus 1004 and executes the program, thereby performing the series of processing described above.

The program to be executed by the computer 1000 (CPU 1001) may be provided by, for example, being recorded in the removable medium 1011 as a package medium or the like. Furthermore, the program may be provided through a wired or wireless transmission medium such as a local area network, the Internet, and digital satellite broadcasting.

In the computer 1000, the program may be installed in the recording unit 1008 via the input/output interface 1005 by attaching the removable medium 1011 to the drive 1010. Furthermore, the program may be received by the communication unit 1009 via a wired or wireless transmission medium and installed in the recording unit 1008. In addition, the program may be installed in the ROM 1002 or the recording unit 1008 in advance.

Note that the program to be executed by the computer may be a program in which processing is executed in a time-series manner according to the order described in the present specification, or may be a program in which processing is executed in parallel or at a necessary timing such as when a call is made.

Furthermore, in the present specification, a system indicates a set of a plurality of constituent elements (devices, modules (parts), etc.), and it does not matter whether or not all the constituent elements are in the same housing. Therefore, a plurality of devices housed in separate housings and connected through a network, and one device in which a plurality of modules is housed in one housing are both systems.

Moreover, an embodiment of the present technology is not limited to the embodiments described above, and various modifications may be made without departing from the gist of the present technology.

For example, the present technology may employ a configuration of cloud computing in which one function is shared and jointly processed by a plurality of devices via a network.

Furthermore, each step described in the flowcharts described above may be executed by one device or shared by a plurality of devices.

Moreover, in a case where a plurality of processes is included in one step, the plurality of processes included in the one step may be executed by one device or shared by a plurality of devices.

<Exemplary Configuration Combination>

The present technology may also employ the following configurations.

(1)

A signal processing device including:
a recognition unit that recognizes content of a captured image imaged by an imaging unit;
a text information generation unit that generates text information including data representing the recognized content of the captured image in characters; and
a transmission control unit that controls transmission of the text information.

(2)

The signal processing device according to (1) described above, in which
the signal processing device is provided in a vehicle, and
the text information generation unit generates the text information on the basis of the recognized content of the captured image and content of received data from at least one of the inside of the vehicle or the outside of the vehicle.

(3)

The signal processing device according to (2) described above, in which
the text information includes data representing, in characters, information associated with abnormality of at least one of the vehicle or surroundings of the vehicle.

(4)

The signal processing device according to (3) described above, in which
the information associated with abnormality includes at least one of a characteristic of another vehicle around the vehicle, a state of the another vehicle, a characteristic of a driver of the another vehicle, a situation of an accident, a characteristic of the vehicle, a state of the vehicle, a characteristic of a driver of the vehicle, or a state of the driver of the vehicle.

(5)

The signal processing device according to (4) described above, in which
the characteristic of the another vehicle includes contents of a license plate of the another vehicle.

(6)

The signal processing device according to any one of (1) to (5) described above, further including:
an abnormality detection unit that detects abnormality on the basis of the recognized content of the captured image, in which
the transmission control unit controls the transmission of the text information on the basis of a detection result of the abnormality.

(7)

The signal processing device according to (6) described above, in which
the transmission control unit starts the transmission of the text information in a case where the abnormality is detected.

(8)

The signal processing device according to (7) described above, in which
the text information generation unit continuously generates the text information regardless of the detection result of the abnormality, and
in the case where the abnormality is detected, the transmission control unit starts the transmission of the text information, and transmits the text information during a period from a predetermined time before until the abnormality is detected.

(9)

The signal processing device according to (7) described above, in which
the text information generation unit starts generation of the text information in a case where a sign of the abnormality is detected.

(10)

The signal processing device according to (6) described above, in which
the text information generation unit starts generation of the text information in a case where a sign of the abnormality is detected, and
the transmission control unit starts the transmission of the text information in a case where the sign of the abnormality is detected.

(11)

The signal processing device according to (10) described above, in which
the text information includes data representing information associated with the sign of the abnormality in characters.

(12)

The signal processing device according to (10) described above, in which
the signal processing device is provided in a vehicle, and
the sign of the abnormality includes at least one of a risk factor for an accident of the vehicle or an operation of the vehicle for avoiding the accident.

(13)

The signal processing device according to any one of (6) to (12) described above, in which
the text information includes data representing information associated with the abnormality in characters.

(14)

The signal processing device according to any one of (6) to (13) described above, further including:
a receiving unit that receives data including information associated with the abnormality, in which
the text information further includes data representing content of the received data in characters.

(15)

The signal processing device according to (14) described above, in which
the abnormality detection unit further detects the abnormality on the basis of the received data.

(16)

The signal processing device according to (14) or (15) described above, in which
the received data includes voice data, and
the text information includes data representing content of voice recognition of the voice data in characters.

(17)

The signal processing device according to (1) described above, in which
the imaging unit images a predetermined monitoring area, and
the text information includes data representing information associated with a situation of the monitoring area in characters.

(18)

The signal processing device according to any one of (1) to (17) described above, further including:
the imaging unit.

(19)

The signal processing device according to (18) described above, further including:
an image sensor including the imaging unit and the recognition unit.

(20)

A signal processing method including:
recognizing content of a captured image imaged by an imaging unit;
generating text information including data representing the recognized content of the captured image in characters; and
controlling transmission of the text information.

(21)

A program for causing a computer to execute a process including:
recognizing content of a captured image imaged by an imaging unit;
generating text information including data representing the recognized content of the captured image in characters; and
controlling transmission of the text information.

(22)

An imaging device including:
an imaging unit;
a recognition unit that recognizes content of a captured image imaged by the imaging unit;
a text information generation unit that generates text information including data representing the recognized content of the captured image in characters; and
a transmission control unit that controls transmission of the text information.

Note that the effects described herein are merely examples and not limited, and additional effects may be included.

### REFERENCE SIGNS LIST

10 Vehicle
100 Vehicle control system
101 Input unit
102 Data acquisition unit
103 Communication unit
141 Vehicle exterior information detection unit
142 In-vehicle information detection unit
143 Vehicle state detection unit
153 Situation recognition unit
201 Signal processing system
211 Imaging unit
212 Receiving unit
213 Signal processing unit
214 Transmission unit
221 Recognition unit
222 Text information generation unit
223 Abnormality Detection unit
224 Transmission control unit
301 Signal processing system
311 Signal processing unit
321 Abnormality Detection unit
322 Text information generation unit
323 Transmission control unit

1. A signal processing device comprising:
a recognition unit that recognizes content of a captured image imaged by an imaging unit;
a text information generation unit that generates text information including data representing the recognized content of the captured image in a character; and
a transmission control unit that controls transmission of the text information.

2. The signal processing device according to claim 1, wherein
the signal processing device is provided in a vehicle, and
the text information generation unit generates the text information on a basis of the recognized content of the captured image and content of received data from at least one of an inside of the vehicle or an outside of the vehicle.

3. The signal processing device according to claim 2, wherein
the text information includes data representing, in a character, information associated with abnormality of at least one of the vehicle or surroundings of the vehicle.

4. The signal processing device according to claim 3, wherein
the information associated with abnormality includes at least one of a characteristic of another vehicle around the vehicle, a state of the another vehicle, a characteristic of a driver of the another vehicle, a situation of an accident, a characteristic of the vehicle, a state of the vehicle, a characteristic of a driver of the vehicle, or a state of the driver of the vehicle.

5. The signal processing device according to claim 4, wherein
the characteristic of the another vehicle includes contents of a license plate of the another vehicle.

6. The signal processing device according to claim 1, further comprising:
an abnormality detection unit that detects abnormality on a basis of the recognized content of the captured image, wherein
the transmission control unit controls the transmission of the text information on a basis of a detection result of the abnormality.

7. The signal processing device according to claim 6, wherein
the transmission control unit starts the transmission of the text information in a case where the abnormality is detected.

8. The signal processing device according to claim 7, wherein
the text information generation unit continuously generates the text information regardless of the detection result of the abnormality, and
in the case where the abnormality is detected, the transmission control unit starts the transmission of the text information, and transmits the text information during a period from a predetermined time before until the abnormality is detected.

9. The signal processing device according to claim 7, wherein
the text information generation unit starts generation of the text information in a case where a sign of the abnormality is detected.

10. The signal processing device according to claim 6, wherein
the text information generation unit starts generation of the text information in a case where a sign of the abnormality is detected, and
the transmission control unit starts the transmission of the text information in a case where the sign of the abnormality is detected.

11. The signal processing device according to claim 10, wherein
the text information includes data representing information associated with the sign of the abnormality in a character.

12. The signal processing device according to claim 10, wherein
the signal processing device is provided in a vehicle, and
the sign of the abnormality includes at least one of a risk factor for an accident of the vehicle or an operation of the vehicle for avoiding the accident.

13. The signal processing device according to claim 6, wherein
the text information includes data representing information associated with the abnormality in a character.

14. The signal processing device according to claim 6, further comprising:
a receiving unit that receives data including information associated with the abnormality, wherein
the text information further includes data representing content of the received data in a character.

15. The signal processing device according to claim 14, wherein
the abnormality detection unit further detects the abnormality on a basis of the received data.

16. The signal processing device according to claim 14, wherein
the received data includes voice data, and
the text information includes data representing content of voice recognition of the voice data in a character.

17. The signal processing device according to claim 1, wherein
the imaging unit images a predetermined monitoring area, and
the text information includes data representing information associated with a situation of the monitoring area in a character.

18. The signal processing device according to claim 1, further comprising:
the imaging unit.

19. The signal processing device according to claim 18, further comprising:
an image sensor including the imaging unit and the recognition unit.

20. A signal processing method comprising:
recognizing content of a captured image imaged by an imaging unit;
generating text information including data representing the recognized content of the captured image in a character; and
controlling transmission of the text information.

21. A program for causing a computer to execute a process comprising:
recognizing content of a captured image imaged by an imaging unit;
generating text information including data representing the recognized content of the captured image in a character; and
controlling transmission of the text information.

22. An imaging device comprising:
an imaging unit;
a recognition unit that recognizes content of a captured image imaged by the imaging unit;
a text information generation unit that generates text information including data representing the recognized content of the captured image in a character; and
a transmission control unit that controls transmission of the text information.
